(19) United States
(12) Patent Application Publication
(10) Pub. No.: US 2010/0071835 A1
(43) Pub. Date: Mar. 25, 2010

(54) Fixing Adhered Workpieces

(75) Inventors: Thomas Schwoerer, Schramberg (DE); Frank Faisst, Schramberg (DE); Hubertus Melbert, Fluorn-Winzeln (DE)

Correspondence Address: FISH & RICHARDSON PC, P.O. BOX 1022, MINNEAPOLIS, MN, 55440-1022, US

(73) Assignee: Trumpf Laser-und Systemtechnik GmbH, Ditzingen (DE)

(21) Appl. No.: 12/568,025

(22) Filed: Sep. 28, 2009

Related U.S. Application Data
(63) Continuation of application No. PCT/EP2008/001825, filed on Mar. 7, 2008.

(30) Foreign Application Priority Data
Mar. 28, 2007 (EP) 07006363.1

(51) Int. Cl. B29C 65/16

(52) U.S. Cl. 156/87

(57) ABSTRACT

A method for fixing adhesive-bonded includes directing an energy beam upon two or more workpieces and thereby causing localized evaporation of an adhesive disposed therebetween within an effective zone of action of the energy beam; and maintaining a vapor channel in a weld pool within the effective zone of action of the energy beam during the evaporation of the adhesive for releasing gas generated during the evaporation of the adhesive. The adhesive has an evaporation temperature that is less than a melting temperature of a material of the workpieces. The adhesive has a viscosity that substantially inhibits an ingress of the gas generated during the evaporation of the adhesive.

### CROSS REFERENCE TO RELATED APPLICATIONS

This application is a continuation of and claims priority under 35 U.S.C. §120 to PCT Application No. PCT/EP2008/001825, filed on Mar. 7, 2008, which claimed priority to European Application No. EP 07006363.1, filed on Mar. 28, 2007. The contents of both of these priority applications are hereby incorporated by reference in their entirety.

### TECHNICAL FIELD

The invention relates to fixing, e.g., laser welding, structural-adhesive-bonded workpieces.

### BACKGROUND

It has become a known practice in the joining technology to join workpieces provided with a coating and/or an adhesive layer to one another. Such joining is done by a combination of a bonding technique with a thermal or mechanical joining procedure in order to join the component parts to one another. This type of joining is often used in modern automotive lightweight application in order to achieve improved structural integrity and operational stability features of such component parts.

A known method for fixing structural-adhesive-bonded workpieces avoids the utilization of coatings and/or adhesives in the effective range of action of the energy beam. However, for reasons of fabrication tolerances, a tightness of such component parts may not be ensured at the joints or overlapping areas in which the points of material engagement are provided. This may lead to unwanted corrosion.

A method for welding bonded metal sheets, in which the workpieces to be joined are provided with an adhesive layer in the overlapping joint, is known from U.S. Pat. No. 6,932,879. An adhesive layer includes inclusion bodies that serve as spacers between the workpieces to be joined. The inclusion bodies help to provide a defined distance between the workpieces, e.g., to prevent the adhesive from being squeezed out from the gap. The adhesive provided between the workpieces is set such that, during the creation of the material engagement between the bonded workpieces, gas releasing channels may be formed through which gases are removed from the effective zone of action through the lap joint to the surrounding atmosphere or at least to the outer regions of the joint. Single-component or two-component, cured adhesives yielding to the escaping gas are used in order to form such gas releasing or gas outlet passageways. However, once the material engagement between the workpieces is established, the gas releasing channels will remain, such that moisture may enter the space between the workpieces. Thus, tightness between the workpieces may not be ensured. In addition, it may be necessary that the overlapping joints and/or their neighboring zones be adapted to the formation of the gas releasing channels in order to obtain the desired effect. Moreover, it is recommended that the curing of the adhesive be accomplished before the creation of the material engagement between the workpieces, since otherwise the adhesive may flow into the weld pool and, as a result, there would be a risk of pore formation and spittings of molten material.

Furthermore, a method for welding coated metal sheets by means of an energy beam is known from U.S. Pat. No. 6,359,252 in which a gas release is designed to occur through a weld pool that is to be produced in an effective zone of action of the energy beam. For this purpose, during the creation of a material engagement between the metal sheets a channel is designed to be realized between the sheets which forms a space between the workpieces to be joined together permitting the vapor to escape into the weld pool. In order to keep the vapor (gas) from escaping into the space between the sheets, the sheets are pressed together. In addition, a further energy beam is provided which pierces a vapor bubble forming in the weld pool while the welded material is in a molten condition in order to permit the gas to escape. This method calls for a sensitive and complex sensor design and involves extensive equipment outlays to be able to achieve a piercing of a vapor bubble within a time span corresponding to the duration of action of the energy beam used for creating a point of material engagement in the effective zone of action. Furthermore, such a method may require a high process complexity in order to generate, and subsequently pierce, the vapor bubble in the weld pool and to close the cavity in the weld pool, once the gas bubble has been expelled.

### SUMMARY

The invention relates to fixing, e.g., laser welding, structural-adhesive-bonded workpieces.

One aspect of the invention provides a method for fixing adhesive-bonded workpieces. The method includes directing an energy beam upon two or more workpieces and thereby causing localized evaporation of an adhesive disposed therebetween within an effective zone of action of the energy beam; and maintaining a vapor channel in a weld pool within the effective zone of action of the energy beam during the evaporation of the adhesive for releasing gas generated during the evaporation of the adhesive. The adhesive has an evaporation temperature that is less than a melting temperature of a material of the workpieces. The adhesive has a viscosity that substantially inhibits an ingress of the gas generated during the evaporation of the adhesive.

In some embodiments, the energy beam is directed to the effective zone of action prior to, or during, a curing phase of the adhesive.

In certain embodiments, the vapor channel is maintained in the weld pool until a critical gas pressure of the evaporating adhesive is reached.

In some cases, a continuous layer of the adhesive is disposed between the workpieces, and within and along the effective zone of action of the energy beam.

The method can also include forming a gas pressure in the weld pool during the evaporation of the adhesive, thereby substantially inhibiting inflow of the adhesive into the weld pool.

In some embodiments, a duration of action of the energy beam upon the two or more workpieces is one second or less.

In certain embodiments, the energy beam is a pulsed laser beam or a CW laser beam

In some cases, directing the energy beam upon the two or more workpieces is performed during a welding operation selected from spot welding, seam sealing, or butt welding the workpieces.

In some embodiments, the adhesive includes inclusion bodies, such as glass beads.

Directing the energy beam upon the two or more workpieces can include performing a penetration welding operation on the two workpieces. In the penetration welding operation, the vapor channel can be oriented towards a top surface or a bottom surface of a composite workpiece assembly comprising the two or more workpieces.

Directing the energy beam upon the two or more workpieces can include performing an inclusion welding operation on the two workpieces. In certain embodiments, the vapor channel is oriented toward a energy source providing the energy beam.

The method can also include activating the energy beam for a relatively short duration to provide a relatively large temperature gradient between the effective zone of action of the energy beam and a zone adjacent thereto.

In some embodiments, the method also includes taking over parameters used in a welding operation for workpieces arranged in a lap joint without an adhesive layer or without a coating by adapting a process duration.

In certain embodiments, the workpieces are coated with a zinc coating.

Directing the energy beam upon the two or more workpieces can be performed during a seam welding operation. The seam welding operation can include forming a plurality of butt weldings or spot weldings.

Another aspect of the invention features a method for fixing adhesive-bonded workpieces that includes applying an adhesive between a pair of workpieces; directing an energy beam upon the workpieces and thereby forming a point of material engagement between the workpieces; and maintaining a vapor channel in a weld pool in an effective zone of action of the energy beam during the formation of the point of material engagement. At least part of the adhesive situated within the zone of action of the energy beam evaporates and gas generated by the evaporation of the adhesive escapes through the vapor channel during the formation of the point of material engagement. The adhesive has a viscosity that substantially inhibits an ingress of the gas generated by the evaporation of the adhesive during the formation of the point of material engagement.

In some embodiments, the point of material engagement is formed before the adhesive is completely cured.

In certain embodiments, the formation of the point of material engagement takes less than 0.5 seconds.

In another aspect of the invention a method of fixing adhesive-bonded workpieces uses an adhesive layer having a viscosity which is such that adhesive evaporated in an effective zone of action during a duration of action of an energy beam is prevented from entering a neighboring zone of the adhesive layer between the workpieces, adjacent to the effective zone of action. By an adequate setting of the viscosity of the adhesive layer, it is possible to avoid the formation of pores and/or gas releasing channels in the adhesive layer between the workpieces. At the same time the produced gas is caused to pass into a weld pool from where it may escape via a vapor channel that is maintained therein. This allows a good tightness between the workpieces to be joined together by structural-adhesive-bonding, particularly in the lap joint or overlapping zone, to be achieved. A zone adjacent to the effective zone of action of the energy beam remains sealed, such that a sealing adhesive layer is provided immediately adjacent to the effective zone of action. Furthermore, by maintaining a vapor channel in the weld pool, the forming of a vapor bubble is prevented. Thus, an after-treatment or additional treatment of the weld pool so as to pierce it by means of a second energy beam is not required.

In some embodiments, the energy beam is directed onto an effective zone of action for creating a point of material engagement between the workpieces before or during a curing phase of the adhesive layer. This can allow for a high process speed for the joining process, with the advantages for the fixing of structural-adhesive-bonded workpieces being maintained. In addition, when the energy beam is used, the workpieces are fixed in such a way prior to the beginning of the curing phase that they cannot be displaced any more relative to each other during the curing phase.

In certain embodiments, the vapor channel in the weld pool is designed to be maintained until the critical gas pressure of the evaporating adhesive layer has been reached. This can help to inhibit (e.g., prevent) the formation of spittings of molten material in the weld pool. At the same time, a formation of gas releasing channels and/or pores in a zone of the adhesive layer adjoining the effective zone of action is inhibited (e.g., prevented).

In some cases, a continuous adhesive layer is provided in and along the effective zone of action of the energy beam used to create a joint of material engagement between the workpieces. This can provide a good tightness particularly in the lap joint of the workpieces that are to be joined together by means of structural-adhesive-bonding.

In some embodiments, the duration of action and the intensity of the energy beam are designed to form a gas pressure in the weld pool that prevents the adhesive layer from flowing into the weld pool or which reduces said inflow to a minimum. Thus the contamination of the weld pool can be reduced, if not avoided.

The formation of the viscosity of the adhesive holding the gas pressure contained therein, on the one hand, and the maintaining of the vapor channel at least during the duration of action of the energy beam, on the other, has as a further consequence that a gas pressure is built up in a zone adjoining the effective zone of action, whereby the adhesive layer is prevented from flowing, due to a temperature-related viscosity drop, into the effective zone of action of the energy beam and from contaminating the weld pool with additional combustion residues.

The duration of action of the energy beam upon a given effective zone of action can be limited to a maximum of one second, and, in some cases, a few tenths of a second. This short process duration makes it possible to reduce the time available for the build-up of the gas pressure, which, as a result, will be minimized. In addition, the zone around the weld zone affected by the temperature-related viscosity drop may thus be kept small. Moreover, the resulting larger temperature gradient contributes to avoid the formation of gas releasing channels within the adhesive and thus encourages the releasing of gas through the weld pool.

In some embodiments, the acting energy beam is a laser beam. By using a laser beam, it is possible to preserve a much greater part of the adhesive layer from destruction as would be the case with other welding methods, which may, however, also be used. The welding may be carried out with a focused or defocused laser beam. Furthermore, other downstream laser process steps may be provided. The laser welding may be carried out with a pulsed laser and/or a CW laser.

In addition, the point of material engagement between the at least two workpieces may advantageously be designed to be created by spot welding, seam welding, or butt welding. It may also be envisaged to generate seam weldings that include a plurality of butt weldings or even spot weldings. In this respect, the individual process parameters will be adapted to the thickness of the workpieces, the material of the workpieces, and also to the geometry and configuration of the lap joints.

The adhesive layer may be provided with inclusion bodies. This makes it possible to position the workpieces that are arranged relative to each other in a lap joint with a predetermined play, or gap, with respect to each other.

In the case of a penetration welding of at least two adjacent workpieces that are to be joined together to form a composite workpiece assembly, the vapor channel is oriented towards a top surface or a bottom surface of the composite workpiece assembly. Thus, the gas may escape both via the top surface or the bottom surface, such that the orientation of the vapor channel may be configured depending on the geometry to be realized.

Alternatively, in the case of an inclusion welding of at least two adjacent workpieces, the vapor channel is designed to be oriented towards a top surface of the workpiece acted upon by the energy beam. Thus a releasing of a sufficient amount of gas can be ensured and the formation of gas releasing channels in the adhesive layer between the workpieces to be joined together can be avoided.

In certain embodiments, a large temperature gradient between the effective zone of action of the energy beam and the zone adjacent thereto is designed to be achieved by a reduced process duration. Thus, the zones adjacent to the weld pool are inhibited (e.g., prevented) from heating and from evaporating, which makes it possible to create a very small transition zone between the weld pool and the workpieces to be joined together. In this way, the adhesive layer may be disposed so as to reach very close to the weld pool, thus forming a sealing for the gap.

In some embodiments, process parameters such as laser intensity, feed rate, and the like may directly be taken over from comparable welding geometries by adapting the duration of action of the energy beam and the selection of the adhesive used. An adaptation of the process parameters and the costs associated therewith may be dispensed with.

The method can carried out using workpieces that are provided with a zinc coating on one side or on both sides. Such zinc-coated metal sheets, which need to have good corrosion resistance, are often used in the field of automotive engineering.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1a is a schematic sectional view of two workpieces to be joined together during a work process in the creation of an inclusion welding;

FIG. 1b is a schematic sectional view of two workpieces to be joined together during a work process in the creation of an inclusion welding using an adhesive layer containing inclusion bodies;

FIG. 2 is a schematic sectional view of two workpieces to be joined together 1.5 according to FIG. 1a after the carrying-out of the method;

FIG. 3 is a schematic sectional view of two workpieces to be joined together after the carrying-out of a method in which a penetration welding is created.

Like reference symbols in the various drawings indicate like elements.

### DETAILED DESCRIPTION

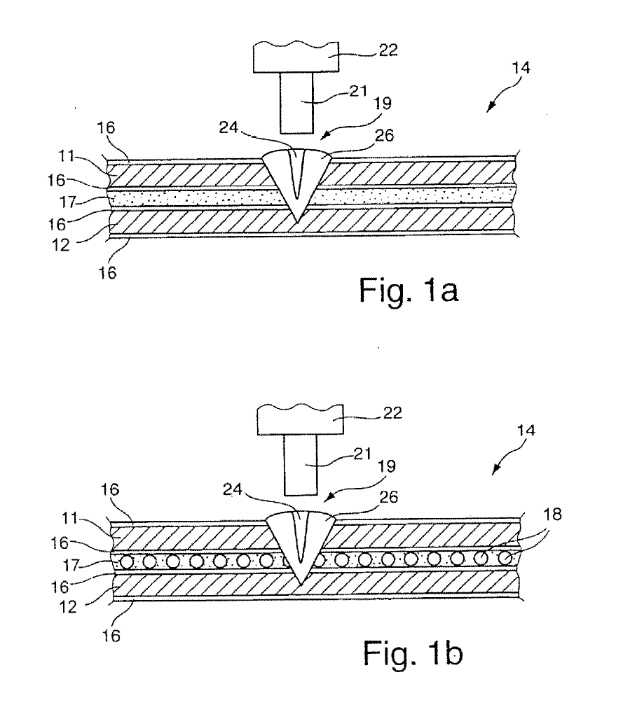

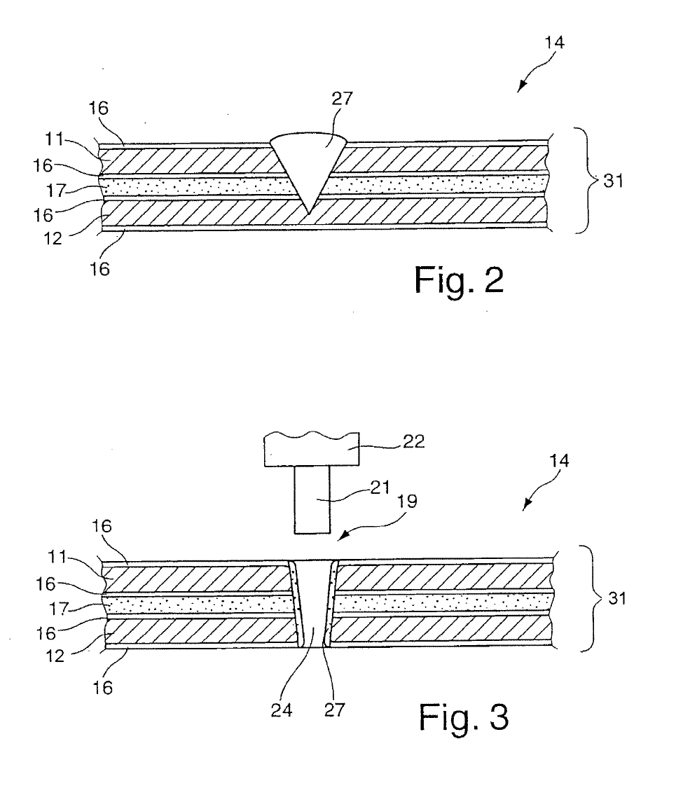

FIG. 1a shows a lap joint 14 formed by workpieces 11 and 12. The workpieces 11 and 12 are joined together by means of an adhesive layer 17. For the purpose of positioning and pre-fixing the workpieces 11 and 12 until the adhesive layer 17 is completely cured, a point of material engagement 27 (FIG. 2) is created.

FIG. 1a two workpieces 11 and 12 being joined together. In such a lap joint 14, it is equally possible to have more layers of workpieces 11, 12 that are joined together.

The points of material engagement 27 between the workpieces 11 and 12 that are created in the effective zones of action 19 by an energy beam 21 are produced before or during a curing phase of the adhesive layer 17. Thus, the points of material engagement 27 in the effective zones of action 19 permit a pre-fixing of the workpieces 11 and 12, such that the workpieces 11, 12 are held in place, with respect to each other, until the curing of the adhesive layer is accomplished.

The energy beam 21 acting upon the effective zone of action 19 can be a laser beam. The laser parameters for the laser beam are selected depending on the type of material and/or the thickness of the workpieces 11, 12, on the coatings 16, if present, and on the adhesive layer 17. In addition, the laser parameters are selected depending on the weld geometry to be fabricated. For example, the weld geometry may be formed by a spot welding, with the possibility for such a spot welding to be realized as an inclusion welding or as a penetration welding. Alternatively, a seam welding or a butt welding may be provided.

The adhesive layer 17 to be used is adapted, as far as its properties are concerned, to the field of application and to the particular use of the workpieces 11 and 12. In automotive engineering, for example, such adhesive layers may have several properties and fulfill several functions such as durability, stiffness, adequate crash behavior or the like.

FIG. 1b illustrates an assembly of workpieces 11, 12 in a lap joint in which an adhesive layer 17 including inclusion bodies 18 is used. These inclusion bodies 18 may, for example, consist of glass beads or other particles as well as particulate material having a predetermined grain size in order to set a predefined gap dimension between the workpieces 11, 12. Such a gap created between the coated workpieces 11 and 12 allows the coating to outgas in the effective zone of action of the energy beam and in the zone immediately adjacent thereto.

The method for fixing bonded workpieces 11, 12 by means of an energy beam 21, in particular a laser beam, can be carried out by the following steps:

The workpieces 11 and 12 are positioned with respect to each other and form a lap joint 14, after an adhesive layer 17 has been applied on one or on both workpiece surfaces. Subsequently, an energy source 22 for emitting an energy beam 21 is positioned next to the lap joint 14 in order to form the weld geometry for creating the points of material engagement between the workpieces 11 and 12. The energy beam 21 acts upon the effective zone of action 19, causing the workpieces 11 and 12, together with the adhesive layer 17 sandwiched therebetween, to locally evaporate. The duration of the activation of the energy beam 21 is short and is limited to 1 s, in particular to some few tenths of a second. As a result, only a small portion of the adhesive layer 17 is destroyed. At the same time, the energy beam 21 is controlled in such a way that a vapor channel 24 is maintained during the evaporation phase, so that vapor produced may fully escape from the weld pool 26.

FIGS. 1a and 1b represent so-called inclusion weldings. The laser beam does not completely penetrate both workpieces 11 and 12. Thus the vapor channel 24 is oriented in the direction of the acting energy beam 21. One of the laser parameters for the laser beam, the pulse power, is preferably designed to be set to a value of at least 2 kW. In some cases, a pulse power of 4 kW or higher is provided so as to keep the duration of the energy input short. This can help to ensure a sufficiently large temperature gradient between the effective zone of action of the laser beam and the zone adjacent thereto.

It is possible to provide further laser process steps downstream of the creation of the joints of material engagement 27. Such laser process steps may include, if necessary, a masking of the welding by the laser beam, with the possibility of carrying out additional passages of the beam with changed laser parameters such as laser intensity, feed rate, focusing, defocusing, and the like. These laser process steps are basically aimed at achieving a tight weld seam and compensating for irregularities therein.

The adhesive layer 17 used has a viscosity that will not yield to an increasing gas pressure that may be caused in the vapor channel or in the zone adjacent thereto by a temperature stress. Thus, a formation of gas releasing channels or pores in a zone immediately adjacent to the weld pool 26 may be avoided. At the same time the gas that is being formed can escape via the weld pool 26 or the vapor channel 24 formed therein.

The adhesives used to form the adhesive layer 17 are defined by a dependency relationship between their viscosity and their shear rate. A standard adhesive has, for example, a viscosity of 1,500 Pas and a shear rate of 0.1 l/s. Adhesives having a viscosity ranging between 50 and 15,000 Pas may be used. Optimized adhesives have, for example, a viscosity of between 3,500 and 6,500 Pas and a shear rate of 0.1 l/s.

The fabrication of butt weldings in which the forming of one butt welding or one spot welding takes less than 0.5 s. of time makes it possible to achieve a very high process rate for the pre-fixing of the workpieces 11, 12 in the lap joint 14.

The workpieces can include galvanized steel sheets, but aluminum alloys with or without plating may also be used. Furthermore advanced high-strength steels (AHSS) may also be used. The latter have the advantage that the thermal action associated with the creation of the point of material engagement causes a post-curing effect which allows a stiffening and a reinforcement of the lap joint, and, in particular, a reduction in material thickness. At the same time it is possible to realize durable joinings provided with high dynamic fatigue and strength rates.

FIG. 2 shows a composite workpiece assembly 31 after the method has been performed. The two workpieces 11 and 12 are pre-fixed with respect to each other by means of a point of material engagement 27 in the form of an inclusion welding and are rigidly joined together by means of an adhesive layer 17 once said layer is completely cured. The pre-fixing of the workpieces 11 and 12 by means of welding, in particular laser welding, as individual welding spots or welding seams, or as a group of welding spots or welding seams, or else as a continuous welding seam in the lap joint 14 permits short process times. Due to this pre-fixing operation, it is not necessary to wait for the adhesive layer 17 to be completely cured in order to initiate any subsequent work steps.

FIG. 3 represents an alternative configuration of the method for joining the workpieces 11 and 12 together. Instead of an inclusion welding as a point of material engagement 27, a penetration welding extending through the two workpieces 11 and 12 is provided, with the rims of the penetration welding being welded together. In the case of a penetration welding, the vapor channel 24 may be oriented both towards the top side and towards the bottom side. For the rest, reference is made to the remarks pertaining to FIGS. 1a, 1b, and 2.

Due to the configuration of the method it is possible to achieve a tight lap joint 14 and an increased process speed while the required performance parameters such as stiffness and strength of the joined workpieces 11, 12 can still be maintained.

A number of embodiments of the invention have been described. Nevertheless, it will be understood that various modifications may be made without departing from the spirit and scope of the invention. Accordingly, other embodiments are within the scope of the following claims.

What is claimed is:

1. A method for fixing adhesive-bonded workpieces, the method comprising:
directing an energy beam upon two or more workpieces and thereby causing localized evaporation of an adhesive disposed therebetween within an effective zone of action of the energy beam; and
maintaining a vapor channel in a weld pool within the effective zone of action of the energy beam during the evaporation of the adhesive for releasing gas generated during the evaporation of the adhesive,
wherein the adhesive has an evaporation temperature that is less than a melting temperature of a material of the workpieces, and
wherein the adhesive has a viscosity that substantially inhibits an ingress of the gas generated during the evaporation of the adhesive.

2. The method of claim 1, wherein the energy beam is directed to the effective zone of action prior to, or during, a curing phase of the adhesive.

3. The method of claim 1, comprising maintaining the vapor channel in the weld pool until a critical gas pressure of the evaporating adhesive is reached.

4. The method of claim 1, wherein a continuous layer of the adhesive is disposed between the workpieces, and within and along the effective zone of action of the energy beam.

5. The method of claim 1, further comprising forming a gas pressure in the weld pool by the energy beam, during the evaporation of the adhesive, thereby substantially inhibiting inflow of the adhesive into the weld pool.

6. The method of claim 1, wherein a duration of action of the energy beam upon the workpieces is one second or less.

7. The method of claim 1, wherein the energy beam is a pulsed laser beam or a CW laser beam

8. The method of claim 1, wherein directing the energy beam upon the two or more workpieces is performed during a welding operation selected from spot welding, seam sealing, or butt welding.

9. The method of claim 1, wherein the adhesive comprises inclusion bodies.

10. The method of claim 9, wherein the inclusion bodies comprise glass beads.

11. The method of claim 1, wherein directing the energy beam upon the two or more workpieces comprises performing a penetration welding operation on the workpieces, and wherein the vapor channel is oriented towards a top surface or a bottom surface of a composite workpiece assembly comprising the two or more workpieces.

12. The method of claim 1, wherein directing the energy beam upon the two or more workpieces comprises performing an inclusion welding operation on the workpieces, and wherein the vapor channel is oriented toward an energy source providing the energy beam.

13. The method of claim 1, wherein directing the energy beam upon the two or more workpieces comprises activating the energy beam for a relatively short duration to provide a relatively large temperature gradient between the effective zone of action of the energy beam and a zone adjacent thereto.

14. The method of claim 1, further comprising taking over parameters used in a welding operation for workpieces arranged in a lap joint without an adhesive layer and without a coating by adapting a process duration.

15. The method of claim 1, further comprising taking over parameters used in a welding operation for workpieces arranged in a lap joint without an adhesive layer or without a coating by adapting a process duration.

16. The method of claim 1, wherein the workpieces are coated with a zinc coating.

17. The method of claim 1, wherein directing the energy beam upon the two or more workpieces is performed during a seam welding operation, and wherein the seam welding operation comprises forming a plurality of butt weldings or spot weldings.

18. A method for fixing adhesive-bonded workpieces, the method comprising:
applying an adhesive between a pair of workpieces;
directing an energy beam upon the workpieces and thereby forming a point of material engagement between the workpieces; and
maintaining a vapor channel in a weld pool in an effective zone of action of the energy beam during the formation of the point of material engagement,
wherein at least part of the adhesive situated within the zone of action of the energy beam evaporates and gas generated by the evaporation of the adhesive escapes through the vapor channel during the formation of the point of material engagement, and
wherein the adhesive has a viscosity that substantially inhibits an ingress of the gas generated by the evaporation of the adhesive during the formation of the point of material engagement.

19. The method of claim 18, wherein the point of material engagement is formed before the adhesive is completely cured.

20. The method of claim 18, wherein the formation of the point of material engagement takes less than 0.5 seconds.

21. The method of claim 18, wherein the formation of the point of material is an inclusion welding.
